(19) United States
(12) Patent Application Publication
(10) Pub. No.: US 2014/0235447 A1
(43) Pub. Date: Aug. 21, 2014

(54) METHODS FOR INCREASING CROP YIELD

(71) Applicants: Syngenta Crop Protection LLC, Greensboro, NC (US); AgroFresh Inc., Spring House, PA (US)

(72) Inventors: Timothy MALEFYT, Stroudsburg, PA (US); Andrew John LEADBEATER, Aesch (CH)

(73) Assignees: Syngenta Crop Protection LLC, Greensboro, NC (US); AgroFresh Inc., Spring House, PA (US)

(21) Appl. No.: 14/180,679

(22) Filed: Feb. 14, 2014

Related U.S. Application Data
(60) Provisional application No. 61/766,184, filed on Feb. 19, 2013.

(51) Int. Cl. A01N 27/00

(52) U.S. Cl. CPC A01N 27/00
USPC 504/357

(57) ABSTRACT

The subject invention is based on unexpected more than additive effect of multiple applications of at least one cyclopropene on crop yield as compared to single applications. Provided are methods of increasing yield of a plant comprising contacting the plant with multiple applications of a cyclopropene. In one aspect, the method comprises (a) contacting the plant with a first composition comprising a cyclopropene; and (b) contacting the plant with a second composition comprising a cyclopropene; thereby increasing the yield of the plant in comparison to a plant not contacted with the first composition and/or the second composition. In another aspect, the method comprises contacting the plant with two or more separate applications of a composition comprising at least one cyclopropene thereby increasing the yield of the plant in comparison to a plant not treated or contacted with two or more separate applications of a composition comprising at least one cyclopropene.

### CROSS-REFERENCE TO RELATED APPLICATION

This application claims the benefit of U.S. Provisional Patent Application Ser. No. 61/766,184, filed Feb. 19, 2013, the disclosure of which is hereby incorporated herein in its entirety by this reference.

### BACKGROUND

For the use of cyclopropenes, a cyclopropene compound is often in the form of a complex with a molecular encapsulating agent. Such a complex is useful, for example, for use in treating plants or plant parts by contacting the plants or plant parts with the complex in order to bring about contact between the plants or plant parts and the cyclopropene compound. Such treatment of plants or plant parts is often effective at desirably interrupting one or more ethylene-mediated process in the plants or plant parts. For example, such treatment of plant parts can sometimes delay unwanted ripening.

U.S. Pat. No. 6,313,068 discloses grinding and milling of dried powder of a complex of cyclodextrin and 1-methylcyclopropene. Progress of improved formulation for cyclopropene compounds can definitely be helpful for field application on crops. However, there remains a need for more effective methods to increase crop yield.

### SUMMARY OF THE INVENTION

The subject invention is based on unexpected more than additive effect of multiple applications of at least one cyclopropene on crop yield as compared to single applications. Provided are methods of increasing yield of a plant comprising contacting the plant with multiple applications of a cyclopropene. In one aspect, the method comprises (a) contacting the plant with a first composition comprising a cyclopropene; and (b) contacting the plant with a second composition comprising a cyclopropene; thereby increasing the yield of the plant in comparison to a plant not contacted with the first composition and/or the second composition. In another aspect, the method comprises contacting the plant with two or more separate applications of a composition comprising at least one cyclopropene thereby increasing the yield of the plant in comparison to a plant not treated or contacted with two or more separate applications of a composition comprising at least one cyclopropene.

In one aspect, provided is a method of increasing the yield of a plant. The method comprises (a) contacting the plant with a first composition comprising a cyclopropene; and (b) contacting the plant with a second composition comprising a cyclopropene; thereby increasing the yield of the plant in comparison to a plant not contacted with the first composition and/or the second composition.

In some embodiments, the yield increased may be 1, 2, 3, 4, 5, 6, 7, 8, 9, 10, 20, 30, 40, 50, 60, 70, 80, 90, 100, 125, 150, 175, 200, 225, 250, 275, or 300 percent per hectare in comparison plants treated with one or less applications of cyclopropene.

In one embodiment, the yield of the plant is increased by at least 5 percent. In another embodiment, the yield of the plant is increased by at least 15 percent. In another embodiment, the yield of the plant is increased between 10%-20%, 10%-50%, 20%-50%, or 30%-80%.

In some embodiments, the step (a) and step (b) may be separated by 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or 31 days.

In one embodiment, the step (a) and step (b) are separated by at least twenty-four hours. In another embodiment, the step (a) and step (b) are separated by at least forty-eight hours. In another embodiment, the step (a) and step (b) are separated by at least four days. In another embodiment, the step (a) and step (b) are separated by 3-5, 3-10, 5-10, 10-30, or 20-90 days.

In one embodiment, the cyclopropene is part of a cyclopropene molecular complex. In a further embodiment, the cyclopropene molecular complex comprises an inclusion complex.

In another embodiment, the cyclopropene molecular complex comprises a cyclopropene and a molecular encapsulating agent. In a further embodiment, the molecular encapsulating agent is selected from the group consisting of substituted cyclodextrins, unsubstituted cyclodextrins, crown ethers, zeolites, and combinations thereof. In a further embodiment, the molecular encapsulating agent is a cyclodextrin. In a further embodiment, the cyclodextrin is selected from the group consisting of alpha-cyclodextrin, beta-cyclodextrin, gamma-cyclodextrin, and combinations thereof.

In one embodiment, the first or second composition comprises at least 5 g/hectare of the cyclopropene. In another embodiment, the first or second composition comprises at least 10 g/hectare of the cyclopropene. In another embodiment, the first or second composition comprises 5-10, 5-25, 10-25, 10-50, or 5-100 g/hectare of the cyclopropene. In another embodiment, the first composition is the same as the second composition.

In one embodiment, the cyclopropene is of the formula:

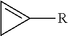

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

In a further embodiment, R is C₁₋₈ alkyl. In another embodiment, R is methyl.

In another embodiment, the cyclopropene is of the formula:

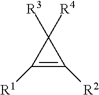

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen.

In a further embodiment, the cyclopropene comprises 1-methylcyclopropene (1-MCP).

In another aspect, provided is a method of increasing the yield of a plant. The method comprises contacting the plant with two or more separate applications of a composition comprising at least one cyclopropene thereby increasing the yield of the plant in comparison to a plant not treated contacted with two or more separate applications of a composition comprising at least one cyclopropene.

In some embodiments, the yield increased may be 1, 2, 3, 4, 5, 6, 7, 8, 9, 10, 20, 30, 40, 50, 60, 70, 80, 90, 100, 125, 150, 175, 200, 225, 250, 275, or 300 percent per hectare in comparison plants treated with one or less applications of cyclopropene.

In one embodiment, the yield of the plant is increased by at least 5 percent. In another embodiment, the yield of the plant is increased by at least 15 percent. In another embodiment, the yield of the plant is increased between 10%-20%, 10%-50%, 20%-50% or 30%-80%.

In some embodiments, the step (a) and step (b) may be separated by 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or 31 days.

In one embodiment, the step (a) and step (b) are separated by at least twenty-four hours. In another embodiment, the step (a) and step (b) are separated by at least forty-eight hours. In another embodiment, the step (a) and step (b) are separated by at least four days. In another embodiment, the step (a) and step (b) are separated by 3-5, 3-10, 5-10, 10-30, or 20-90 days.

In one embodiment, the cyclopropene is part of a cyclopropene molecular complex. In a further embodiment, the cyclopropene molecular complex comprises an inclusion complex.

In another embodiment, the cyclopropene molecular complex comprises a cyclopropene and a molecular encapsulating agent. In a further embodiment, the molecular encapsulating agent is selected from the group consisting of substituted cyclodextrins, unsubstituted cyclodextrins, crown ethers, zeolites, and combinations thereof. In a further embodiment, the molecular encapsulating agent is a cyclodextrin. In a further embodiment, the cyclodextrin is selected from the group consisting of alpha-cyclodextrin, beta-cyclodextrin, gamma-cyclodextrin, and combinations thereof.

In one embodiment, the first or second composition comprises at least 5 g/hectare of the cyclopropene. In another embodiment, the first or second composition comprises at least 10 g/hectare of the cyclopropene. In another embodiment, the first or second composition comprises 5-10, 5-25, 10-25, 10-50, or 5-100 g/hectare of the cyclopropene. In another embodiment, the first composition is the same as the second composition.

In one embodiment, the cyclopropene is of the formula:

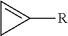

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

In a further embodiment, R is C₁₋₈alkyl. In another embodiment, R is methyl.

In another embodiment, the cyclopropene is of the formula:

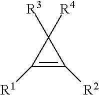

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen.

In a further embodiment, the cyclopropene comprises 1-methylcyclopropene (1-MCP).

### BRIEF DESCRIPTION OF THE DRAWINGS

FIG. 1 shows an exemplary graphical representation of the effects of single versus multiple treatments of tropical corn with cyclopropene, the yield being measured in kg/hectare. For each dosage amount, the left bar designates treatment 1 (a single dose at the stage of 3-5 fully collared leaves), the middle bar designates treatment 2 (a single dose at the stage of 10 leaves), and the right hand bar designates treatment 3 (dosed at both the stage of 3-5 fully collared leaves and again at the 10 leaf stage).

FIG. 2 shows an exemplary graphical representation of the effects of single versus multiple treatments of cotton with cyclopropene, the yield being measured in tons/hectare. For each treatment condition, four separate plantings were treated, as represented by the four contiguous bars for each condition presented in the figure. Treatment A designates application of cyclopropene at the stage of Pin Head Square +14 days. Treatment B designates application of cyclopropene at the stage of first flower. Treatment C designates application of cyclopropene at first flower +14 days.

### DETAILED DESCRIPTION OF THE INVENTION

As used herein, a cyclopropene is any compound with the formula

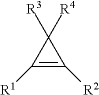

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof In any one R group (i.e., any one of R¹, R², R³ and R⁴) the total number of heteroatoms (i.e., atoms that are neither H nor C) is from 0 to 6. Independently, in any one R group the total number of non-hydrogen atoms is 50 or less. Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups are independently selected from the suitable groups. The R¹, R², R³, and R⁴ groups may be the same as each other, or any number of them may be different from the others. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof Groups that are suitable for use as one or more of R¹, R², R³, and R⁴ may be substituted or unsubstituted. Independently, groups that are suitable for use as one or more of R¹, R², R³, and R⁴ may be connected directly to the cyclopropene ring or may be connected to the cyclopropene ring through an intervening group, such as, for example, a heteroatom-containing group.

Among the suitable R¹, R², R³, and R⁴ groups are, for example, aliphatic groups. Some suitable aliphatic groups include, but are not limited to, alkyl, alkenyl, and alkynyl groups. Suitable aliphatic groups may be linear, branched, cyclic, or a combination thereof Independently, suitable aliphatic groups may be substituted or unsubstituted.

As used herein, a chemical group of interest is said to be “substituted” if one or more hydrogen atoms of the chemical group of interest is replaced by a substituent. It is contemplated that such substituted groups may be made by any method, including but not limited to making the unsubstituted form of the chemical group of interest and then perfouning a substitution. Suitable substituents include, but are not limited to, alkyl, alkenyl, acetylamino, alkoxy, alkoxyalkoxy, alkoxycarbonyl, alkoxyimio, carboxy, halo, haloalkoxy, hydroxy, alkylsulfonyl, alkylthio, trialkylsilyl, dialkylamino, and combinations thereof. An additional suitable substituent, which, if present, may be present alone or in combination with another suitable substituent, is

-(L)ₘ-Z

where m is 0 to 8, and where L and Z are defined herein above. If more than one substituent is present on a single chemical group of interest, each substituent may replace a different hydrogen atom, or one substituent may be attached to another substituent, which in turn is attached to the chemical group of interest, or a combination thereof

Among the suitable R¹, R², R³, and R⁴ groups are, without limitation, substituted and unsubstituted aliphatic-oxy groups, such as, for example, alkenoxy, alkoxy, alkynoxy, and alkoxycarbonyloxy.

Also among the suitable R¹, R², R³, and R⁴ groups are, without limitation, substituted and unsubstituted alkylphosphonato, substituted and unsubstituted alkylphosphato, substituted and unsubstituted alkylamino, substituted and unsubstituted alkylsulfonyl, substituted and unsubstituted alkylcarbonyl, and substituted and unsubstituted alkylaminosulfonyl, including, without limitation, alkylphosphonato, dialkylphosphato, dialkylthiophosphato, dialkylamino, alkylcarbonyl, and dialkylaminosulfonyl.

Also among the suitable R¹, R², R³, and R⁴ groups are, without limitation, substituted and unsubstituted cycloalkylsulfonyl groups and cycloalkylamino groups, such as, for example, dicycloalkylaminosulfonyl and dicycloalkylamino.

Also among the suitable R¹, R², R³, and R⁴ groups are, without limitation, substituted and unsubstituted heterocyclyl groups (i.e., aromatic or non-aromatic cyclic groups with at least one heteroatom in the ring).

Also among the suitable R¹, R², R³, and R⁴ groups are, without limitation, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, without limitation, substituted and unsubstituted aryl groups. Suitable substituents include those described herein above. In some embodiments, one or more substituted aryl group may be used in which at least one substituent is one or more of alkenyl, alkyl, alkynyl, acetylamino, alkoxyalkoxy, alkoxy, alkoxycarbonyl, carbonyl, alkylcarbonyloxy, carboxy, arylamino, haloalkoxy, halo, hydroxy, trialkylsilyl, dialkylamino, alkylsulfonyl, sulfonylalkyl, alkylthio, thioalkyl, arylaminosulfonyl, and haloalkylthio.

Also among the suitable R¹, R², R³, and R⁴ groups are, without limitation, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, without limitation, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl; butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and napthyl) or aliphatic (including unsaturated aliphatic, partially saturated aliphatic, or saturated aliphatic); and they may be carbocyclic or heterocyclic. Among heterocyclic G groups, some suitable heteroatoms are, without limitation, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In some embodiments, G is a ring system that contains a saturated or unsaturated three-membered ring, such as, without limitation, a substituted or unsubstituted cyclopropane, cyclopropene, epoxide, or aziridine ring.

In some embodiments, G is a ring system that contains a four-membered heterocyclic ring; in some of such embodiments, the heterocyclic ring contains exactly one heteroatom. In some embodiments, G is a ring system that contains a heterocyclic ring with five or more members; in some of such embodiments, the heterocyclic ring contains one to four heteroatoms. In some embodiments, the ring in G is unsubstituted; in other embodiments, the ring system contains 1 to 5 substituents. In some embodiments in which G contains substituents, each substituent may be independently chosen from the substituents described herein above. Also suitable are embodiments in which G is a carbocyclic ring system.

In some embodiments, each G is independently a substituted or unsubstituted phenyl, pyridyl, cyclohexyl, cyclopentyl, cycloheptyl, pyrolyl, furyl, thiophenyl, triazolyl, pyrazolyl, 1,3-dioxolanyl, or morpholinyl. Among these embodiments are included those embodiments, for example, in which G is unsubstituted or substituted phenyl, cyclopentyl, cycloheptyl, or cyclohexyl. In some embodiments, G is cyclopentyl, cycloheptyl, cyclohexyl, phenyl, or substituted phenyl. Among embodiments in which G is substituted phenyl are embodiments, without limitation, in which there are one, two, or three substituents. In some embodiments in which G is substituted phenyl are embodiments, without limitation, in which the substituents are independently selected from methyl, methoxy, and halo.

Also contemplated are embodiments in which R³ and R⁴ are combined into a single group, which may be attached to the number 3 carbon atom of the cyclopropene ring by a double bond. Some of such compounds are described in US Patent Publication 2005/0288189.

In some embodiments, one or more cyclopropenes may be used in which one or more of R¹, R², R³, and R⁴ is hydrogen. In some embodiments, R¹ or R² or both R¹ and R² may be hydrogen. In some embodiments, R³ or R⁴ or both R³ and R⁴ may be hydrogen. In some embodiments, R², R³, and R⁴ may be hydrogen.

In some embodiments, one or more of R¹, R², R³, and R⁴ may be a structure that has no double bond. Independently, in some embodiments, one or more of R¹, R², R³, and R⁴ may be a structure that has no triple bond. In some embodiments, one or more of R¹, R², R³, and R⁴ may be a structure that has no halogen atom substituent. In some embodiments, one or more of R¹, R², R³, and R⁴ may be a structure that has no substituent that is ionic.

In some embodiments, one or more of R¹, R², R³, and R⁴ may be hydrogen or (C₁-C₁₀) alkyl. In some embodiments, each of R¹, R², R³, and R⁴ may be hydrogen or (C₁-C₈) alkyl. In some embodiments, each of R¹, R², R³, and R⁴ may be hydrogen or (C₁-C₄) alkyl. In some embodiments, each of R¹, R², R³, and R⁴ may be hydrogen or methyl. In some embodiments, R¹ may be (C₁-C₄) alkyl and each of R², R³, and R⁴ may be hydrogen. In some embodiments, R¹ may be methyl and each of R², R³, and R⁴ may be hydrogen, and the cyclopropene is known herein as “1-MCP.”

In some embodiments, a cyclopropene may be used that has boiling point at one atmosphere pressure of 50° C. or lower; or 25° C. or lower; or 15° C. or lower. In some embodiments, a cyclopropene may be used that has boiling point at one atmosphere pressure of −100° C. or higher; −50° C. or higher; or −25° C. or higher; or 0° C. or higher.

The cyclopropenes may be prepared by any method. Some suitable methods of preparation of cyclopropenes include, but are not limited to, the processes disclosed in U.S. Pat. Nos. 5,518,988 and 6,017,849.

In some embodiments, the composition may include at least one molecular encapsulating agent for the cyclopropene. In some embodiments, at least one molecular encapsulating agent may encapsulate one or more cyclopropene or a portion of one or more cyclopropene. A complex that contains a cyclopropene molecule or a portion of a cyclopropene molecule encapsulated in a molecule of a molecular encapsulating agent is known herein as a “cyclopropene molecular complex” or “cyclopropene compound complex.” In some embodiments, cyclopropene molecular complexes may comprise at least 1, 2, 3, 4, 5, 6, 7, 8, 9, 10, 20, 30, 32, 40, 50, 60, 70, 80, or 90% (w/w) cyclopropene.

In some embodiments, at least one cyclopropene molecular complex may be present as an inclusion complex. In such an inclusion complex, the molecular encapsulating agent forms a cavity, and the cyclopropene or a portion of the cyclopropene is located within that cavity. In some embodiments of inclusion complexes, there may be no covalent bonding between the cyclopropene and the molecular encapsulating agent. In some embodiments of inclusion complexes, there may be no ionic bonding between the cyclopropene and the molecular encapsulating complex, whether or not there is any electrostatic attraction between one or more polar moiety in the cyclopropene and one or more polar moiety in the molecular encapsulating agent.

In some embodiments of inclusion complexes, the interior of the cavity of the molecular encapsulating agent may be substantially apolar or hydrophobic or both, and the cyclopropene (or the portion of the cyclopropene located within that cavity) is also substantially apolar or hydrophobic or both. While the present invention is not limited to any particular theory or mechanism, it is contemplated that, in such apolar cyclopropene molecular complexes, van der Waals forces, or hydrophobic interactions, or both, cause the cyclopropene molecule or portion thereof to remain within the cavity of the molecular encapsulating agent.

The cyclopropene molecular complexes may be prepared by any means. In one method of preparation, for example, such complexes may be prepared by contacting the cyclopropene with a solution or slurry of the molecular encapsulating agent and then isolating the complex, using, for example, processes disclosed in U.S. Pat. No. 6,017,849. For example, in another method of making a complex in which cyclopropene is encapsulated in a molecular encapsulating agent, the cyclopropene gas may be bubbled through a solution of molecular encapsulating agent in water, from which the complex first precipitates and is then isolated by filtration. In some embodiments, complexes may be made by either of the above methods and, after isolation, may be dried and stored in solid form, for example as a powder, for later addition to useful compositions.

The amount of molecular encapsulating agent may be characterized by the ratio of moles of molecular encapsulating agent to moles of cyclopropene. In some embodiments, the ratio of moles of molecular encapsulating agent to moles of cyclopropene may be 0.1 or larger; 0.2 or larger; 0.5 or larger; or 0.9 or larger. In some embodiments, the ratio of moles of molecular encapsulating agent to moles of cyclopropene may be 2 or lower; or 1.5 or lower.

Suitable molecular encapsulating agents include, without limitation, organic and inorganic molecular encapsulating agents. Suitable organic molecular encapsulating agents include, without limitation, substituted cyclodextrins, unsubstituted cyclodextrins, and crown ethers. Suitable inorganic molecular encapsulating agents include, without limitation, zeolites. Mixtures of suitable molecular encapsulating agents are also suitable. In some embodiments, the encapsulating agent may be alpha-cyclodextrin, beta-cyclodextrin, gamma-cyclodextrin, or a mixture thereof. In some embodiments, alpha-cyclodextrin may be used. In some embodiments, the encapsulating agent may vary depending upon the structure of the cyclopropene or cyclopropenes being used. Any cyclodextrin or mixture of cyclodextrins, cyclodextrin polymers, modified cyclodextrins, or mixtures thereof may also be utilized. Some cyclodextrins are available, for example, from Wacker Biochem Inc., Adrian, Mich. or Cerestar USA, Hammond, Ind., as well as other vendors.

Embodiments include methods of treating plants with a composition comprising one or more cyclopropenes, such as those described herein. In some embodiments, treating the plant two or more times with a composition comprising one or more cyclopropenes inhibits the ethylene response in the plant. The term “plant” is used generically to also include woody-stemmed plants in addition to field crops, potted plants, cut flowers, harvested fruits and vegetables and ornamentals. Examples of plants that can be treated by embodiments include, but are not limited to, those listed below.

In some embodiments, a plant may be treated at levels of cyclopropene that inhibit the ethylene response in the plant. In some embodiments, a plant may be treated at levels that are below phytotoxic levels. The phytotoxic level may vary not only by plant but also by cultivar. In some embodiments, the two or more applications are performed on growing plants. It is contemplated that, in performing the two or more treatment on growing plants, the composition may be contacted with the entire plant or may be contacted with one or more plant parts. Plant parts include any part of a plant, including, but not limited to, flowers, buds, blooms, seeds, cuttings, roots, bulbs, fruits, vegetables, leaves, and combinations thereof. In some embodiments, plants may be treated with cyclopropene prior to the harvesting of the useful plant parts.

The compositions described herein may be brought into contact with plants or plant parts by any method, including, for example, spraying, dipping, drenching, fogging, and combinations thereof In some embodiments, spraying is used.

Suitable treatments may be performed on a plant that is planted in a field, in a garden, in a building (such as, for example, a greenhouse), or in another location. Suitable treatments may be performed on a plant that is planted in open ground, in one or more containers (such as, for example, a pot, planter, or vase), in confined or raised beds, or in other places. In some embodiments, treatment may be performed on a plant that is in a location other than in a building. In some embodiments, a plant may be treated while it is growing in a container, such as, for example, a pot, flats, or portable bed.

When correctly used, cyclopropenes prevent numerous ethylene effects, many of which have been disclosed in U.S. Pat. Nos. 5,518,988 and 3,879,188, both of which are incorporated herein by reference in their entirety. The embodiments described herein may be employed to influence one or more of the plant ethylene responses. Ethylene responses may be initiated by either exogenous or endogenous sources of ethylene. Ethylene responses include, but are not limited to: (i) the ripening and/or senescence of flowers, fruits and vegetables; (ii) the abscission of foliage, flowers and fruit; (iii) the prolongation of the life of ornamentals, such as potted plants, cut flowers, shrubbery and dormant seedlings, (iv) the inhibition of growth in some plants, such as the pea plant; and (v) the stimulation of plant growth in some plants, such as the rice plant.

Vegetables which may be treated include, but are not limited to, leafy green vegetables, such as lettuce (e.g., Lactuea sativa), spinach (Spinaca oleracea) and cabbage (Brassica oleracea); various roots, such as potatoes (Solanum tuberosum), carrots (Daucus); bulbs, such as onions (Allium sp.); herbs, such as basil (Ocimum basilicum), oregano (Origanum vulgare) and dill (Anethum graveolens); as well as soybean (Glycine max), lima beans (Phaseolus limensis), peas (Lathyrus sp.), corn (Zea mays), broccoli (Brassica oleracea italica), cauliflower (Brassica oleracea botrytis) and asparagus (Asparagus officinalis).

Fruits which may be treated by the methods of the present invention to inhibit ripening include, but are not limited to, tomatoes (Lycopersicon esculentum), apples (Malus domestica), bananas (Musa sapientum), pears (Pyrus communis), papaya (Carica papya), mangoes (Mangifera indica), peaches (Prunus persica), apricots (Prunus armeniaca), nectarines (Prunus persica nectarina), oranges (Citrus sp.), lemons (Citrus limonia), limes (Citrus aurantifolia), grapefruit (Citrus paradisi), tangerines (Citrus nobilis deliciosa), kiwi (Actinidia chinenus), melons, such as cantaloupes (C. cantalupensis) and musk melons (C. melo), pineapples (Aranae comosus), persimmon (Diospyros sp.) and raspberries (e.g., Fragaria or Rubus ursinus), blueberries (Vaccinium sp.), green beans (Phaseolus vulgaris), members of the genus Cucumis, such as cucumber (C. sativus) and avocados (Persea americana).

Ornamental plants which may be treated by the methods of the present, include, but are not limited to, potted ornamentals and cut flowers. Potted ornamentals and cut flowers which may be treated include, but are not limited to, azalea (Rhododendron spp.), hydrangea (Macrophylla hydrangea), hibiscus (Hibiscus rosasanensis), snapdragons (Antirrhinum sp.), poinsettia (Euphorbia pulcherima), cactus (e.g., Cactaceae schlumbergera truncata), begonias (Begonia sp.), roses (Rosa sp.), tulips (Tulipa sp.), daffodils (Narcissus sp.), petunias (Petunia hybrida), carnation (Dianthus caryophyllus), lily (e.g., Lilium sp.), gladiolus (Gladiolus sp.), Alstroemeria (Alstroemaria brasiliensis), anemone (e.g., Anemone bland), columbine (Aquilegia sp.), aralia (e.g., Aralia chinesis), aster (e.g., Aster carolinianus), bougainvillea (Bougainvillea sp.), camellia (Camellia sp.), bellflower (Campanula sp.), cockscomb (Celosia sp.), falsecypress (Chamaecyparis sp.), chrysanthemum (Chrysanthemum sp.), clematis (Clematis sp.), cyclamen (Cyclamen sp.), freesia (e.g., Freesia refracta), and orchids of the family Orchidaceae.

Further examples of plants which may be treated include, but are not limited to, cotton (Gossypium spp.), apples, pears, cherries (Prunus avium), pecans (Carva illinoensis), grapes (Vitis vinifera), olives (e.g., Olea europaea), coffee (Cofffea arabica), snapbeans (Phaseolus vulgaris), and weeping fig (Ficus benjamina), as well as dormant seedlings including, but not limited to, those of various fruit trees including apple, ornamental plants, shrubbery, and tree seedlings.

In addition, shrubbery which may be treated include, but are not limited to, privet (Ligustrum sp.), photinea (Photina sp.), holly (Hex sp.), ferns of the family Polypodiaceae, schefflera (Schefflera sp.), aglaonema (Aglaonema sp.), cotoneaster (Cotoneaster sp.), barberry (Berberris sp.), waxmyrtle (Myrica sp.), abelia (Abelia sp.), acacia (Acacia sp.), and bromeliades of the family Bromeliaceae.

As used herein “yield” may refer to the amount of total plant material or any particular useful portion of a plant, such as, but not limited to, flowers, buds, blooms, seeds, cuttings, roots, bulbs, fruits, vegetables, leaves, and combinations thereof.

In some embodiments, the compositions described herein may be used to treat a plant growing in a field. Such a treatment operation may be performed two or more times on a particular group of crop during a single growing season. In some embodiments, the amount of cyclopropene used in any single treatment may be 0.1 gram per hectare (g/ha) or more; or 0.5 g/ha or more; or 1 g/ha or more; or 5 g/ha or more; or 10 g/ha or more; or 25 g/ha or more; or 50 g/ha or more; or 100 g/ha or more. In some embodiments, the amount of cyclopropene used in one application may be 6000 g/ha or less; or 3000 g/ha or less; or 1500 g/ha or less; or 1000 g/ha or less; or 500 g/ha or less; or 250 g/ha or less; or 100 g/ha or less; or 50 g/ha or less; or 25 g/ha or less; or 10 g/ha or less; or 5 g/ha or less; or 1 g/ha or less.

It is to be understood that for purposes of the present specification and claims that the range and ratio limits recited herein can be combined. For example, if ranges of 60 to 120 and 80 to 110 are recited for a particular parameter, it is understood that the ranges of 60 to 110 and 80 to 120 are also contemplated. As a further, independent example, if a particular parameter is disclosed to have suitable minima of 1, 2, and 3, and if that parameter is disclosed to have suitable maxima of 9 and 10, then all the following ranges are contemplated: 1 to 9, 1 to 10, 2 to 9, 2 to 10, 3 to 9, and 3 to 10.

As used herein, the phrase “plant” includes dicotyledons plants and monocotyledons plants. Examples of dicotyledons plants include tobacco, Arabidopsis, soybean, tomato, papaya, canola, sunflower, cotton, alfalfa, potato, grapevine, pigeon pea, pea, Brassica, chickpea, sugar beet, rapeseed, watermelon, melon, pepper, peanut, pumpkin, radish, spinach, squash, broccoli, cabbage, carrot, cauliflower, celery, Chinese cabbage, cucumber, eggplant, and lettuce. Examples of monocotyledons plants include corn, rice, wheat, sugarcane, barley, rye, sorghum, orchids, bamboo, banana, cattails, lilies, oat, onion, millet, and triticale. Examples of fruit include papaya, banana, pineapple, oranges, grapes, grapefruit, watermelon, melon, apples, peaches, pears, kiwifruit, mango, nectarines, guava, persimmon, avocado, lemon, fig, and berries.

As used herein, the phrase “plant material” refers to leaves, stems, roots, flowers or flower parts, fruits, pollen, egg cells, zygotes, seeds, cuttings, cell or tissue cultures, or any other part or product of a plant. In some embodiment, plant material includes cotyledon and leaf

A used herein, the phrase “plant tissue” refers to a group of plant cells organized into a structural and functional unit. Any tissue of a plant in planta or in culture is included, for example: whole plants, plant organs, plant seeds, tissue culture and any groups of plant cells organized into structural and/or functional units.

Embodiments of the present invention are further defined in the following examples. It should be understood that these examples are given by way of illustration only. From the above discussion and these examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

The disclosure of each reference set forth herein is incorporated herein by reference in its entirety.

### EXAMPLES

### Example 1

### Treatment of Tropical Corn with Multiple Applications of 1-MCP

Tropical corn is treated with a combination of extruded granules of dextrose containing 0.1% 1-MCP and coated sand granules also containing 0.1% 1-MCP. The plants are treated with (1) a single application at the stage of 3-5 fully collared leaves; (2) a single application at the stage of 10 leaves; or (3) two applications with a first application at stage of 3-5 fully collared leaves and a second application at the 10 leaf stage. Dosages of 5 g/hectare, 10 g/hectare, and 25 g/hectare 1-MCP are applied for each of the three different treatment regimes.

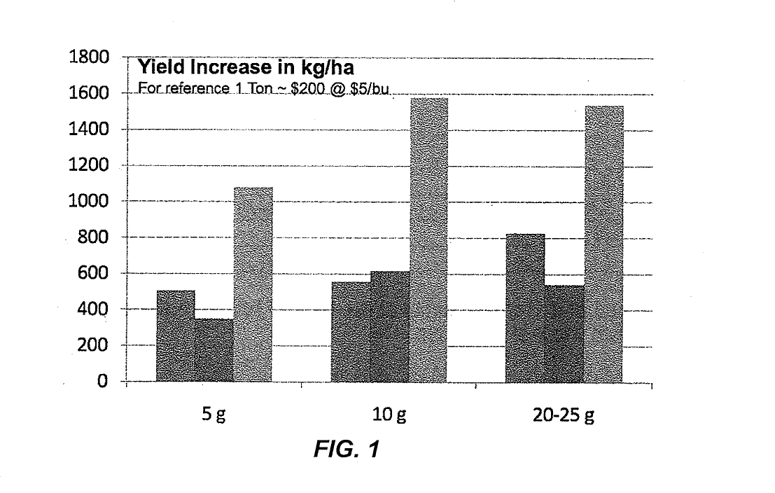

The results are presented in Table 1 and FIG. 1 with yield being measured in kg/hectare. For each dosage amount the left bar designates treatment 1 (a single application at the stage of 3-5 fully collared leaves), the middle bar designates treatment 2 (a single application at the stage of 10 leaves), and the right hand bar designates treatment 3 (application at both the stage of 3-5 fully collared leaves and again at the 10 leaf stage). For each of the 5 g/hectare treatment, the 10 g/hectare treatment, and the 25 g/hectare treatment, the yield is increased by more than 150% for plants undergoing two treatments when compared to plants treated only once.

TABLE 1
Yield increase in kg/ha.

| | Single app. | Single app | Double app. |
|---|---|---|---|
| 1-MCP | @ V3-5 | @ V10 | @ V3&10 |
| 5 g/ha | 506 | 351 | 1082 |
| 10 g/ha | 557 | 618 | 1580 |
| 20-25 g/ha | 826 | 543 | 1539 |

### Example 2

### Treatment of Tropical Cotton with Multiple Applications of 1-MCP

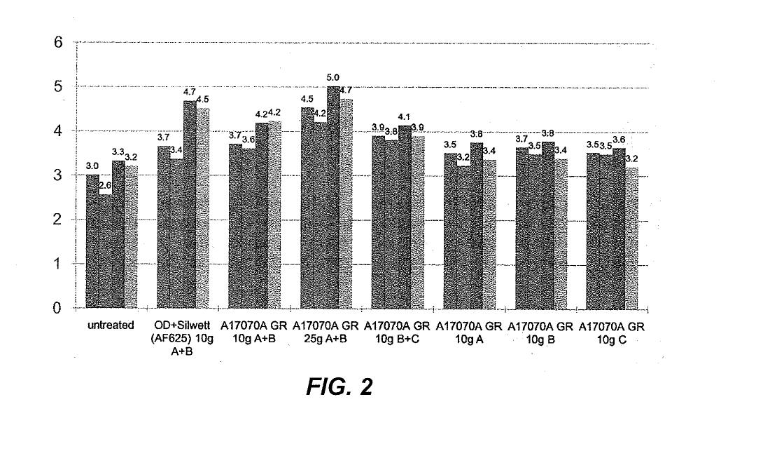

Four different replicates of treatment of cotton are performed. The cotton is treated with dosages of 10 g/hectare or 25 g/hectare 1-MCP with yields being measured in tons per hectare. Treatment A designates application of cyclopropene at the stage of Pin Head Square +14 days. Treatment B designates application of cyclopropene at the stage of first flowers. Treatment C designates application of cyclopropene at first flowers +14 days. Results are shown in Table 2 and FIG. 2.

TABLE 2
Yield differences between treated plots and untreated checks
(kg/ha of seed cotton)

| | Double Applications | | Single Applications | | |
|---|---|---|---|---|---|
| | AB: Floral | BC: Early | A: Floral | | |
| | buds | bloom/10% | buds | | C: 10% |
| | enlarged/ | of bolls | distinctly | B: Early | of bolls |
| | Early | at final | enlarged | bloom | at final |
| | bloom 9.6 | size 9.6 | 9.6 | 9.6 | size 9.6 |
| Trails | GAI/HA | GAI/HA | GAI/HA | GAI/HA | GAI/HA |
| 1 | 560 | 696 | 571 | 839 | 780 |
| 2 | 185 | 262 | 167 | 369 | 280 |
| 3 | 883 | 1042 | 767 | 767 | 792 |
| 4 | 1563 | 1667 | 1132 | 757 | 715 |
| 5 | 375 | 313 | 250 | 106 | −6 |
| Averages | 713 | 796 | 577 | 568 | 512 |

What is claimed is:

1. A method of increasing yield of a plant, comprising:
(a) contacting the plant with a first composition comprising a cyclopropene; and
(b) contacting the plant with a second composition comprising a cyclopropene;
thereby increasing the yield of the plant in comparison to a plant not contacted with the first composition and/or the second composition.

2. The method of claim 1, wherein the yield of the plant is increased by at least 5 percent.

3. The method of claim 1, wherein the step (a) and step (b) are separated by at least twenty-four hours.

4. The method of claim 1, wherein the cyclopropene is part of a cyclopropene molecular complex.

5. The method of claim 4, wherein the cyclopropene molecular complex comprises an inclusion complex.

6. The method of claim 4, wherein the cyclopropene molecular complex comprises a cyclopropene and a molecular encapsulating agent.

7. The method of claim 6, wherein the molecular encapsulating agent is selected from the group consisting of substituted cyclodextrins, unsubstituted cyclodextrins, crown ethers, zeolites, and combinations thereof.

8. The method of claim 6, wherein the molecular encapsulating agent is a cyclodextrin.

9. The method of claim 8, wherein the cyclodextrin is selected from the group consisting of alpha-cyclodextrin, beta-cyclodextrin, gamma-cyclodextrin, and combinations thereof.

10. The method of claim 1 wherein the first or second composition comprises at least 5 g/hectare of the cyclopropene.

11. The method according to claim 1, wherein the cyclopropene is of the formula: 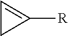
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

12. The method of claim 11, wherein R is C₁₋₈ alkyl.

13. The method of claim 11, wherein R is methyl.

14. The method of claim 11, wherein the cyclopropene is of the formula: 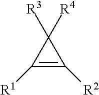
wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen.

15. The method of claim 14, wherein the cyclopropene comprises 1-methylcyclopropene (1-MCP).

16. A method of increasing the yield of a plant, comprising:
contacting the plant with two or more separate applications of a composition comprising at least one cyclopropene thereby increasing the yield of the plant in comparison to a plant not treated contacted with two or more separate applications of a composition comprising at least one cyclopropene.
